(19) United States
(12) Patent Application Publication
(10) Pub. No.: US 2013/0284513 A1
(43) Pub. Date: Oct. 31, 2013

(54) CABLE MANAGEMENT SYSTEM

(71) Applicant: CLO Systems, LLC., (US)

(72) Inventor: Sung I. Oh, West Covina, CA (US)

(73) Assignee: CLO SYSTEMS, LLC., City of Industry, CA (US)

(21) Appl. No.: 13/657,639

(22) Filed: Oct. 22, 2012

Related U.S. Application Data
(60) Provisional application No. 61/628,098, filed on Oct. 24, 2011.
(60) Provisional application No. 61/629,686, filed on Nov. 25, 2011.

(51) Int. Cl. H02G 3/08

(52) U.S. Cl. CPC H02G 3/081
USPC 174/520

(57) ABSTRACT

A cable management system includes a cover adapted to attach to a wall. The cover has a first end and a second end. The first end of the cover has receptacles for electrical power and audio/video signals. A combination of the electrical cord and AV cables may extend from the second end of cover. The electrical cord extending from the second end has an electrical plug to couple to an electrical outlet; and the AV cables extending from the second end of the cover has signal plugs adapted to couple to their respective AV components such as a cable box, DVD player, and the like. The electrical cord and the AV cables may be substantially flat to minimize the overall height of the cover.

### RELATED APPLICATIONS

This application claims priority to two U.S. provisional application numbers: (1) 61/628,098, filed Oct. 24, 2011; and (2) 61/629,686, filed Nov. 25, 2011, which are both hereby incorporated by reference.

### BACKGROUND OF THE INVENTION

1. Field of the Invention

This invention is directed a cable management system adapted transfer power and audio/video signals from a distant location to a position juxtaposed to a monitor, and couple to a supporting surface such as a wall.

2. Background of the Invention

One of the advantages of a flat panel TV such as a computer monitor, LCD, plasma, slim television, and the like (collectively referred to as “monitor(s)”) is that they can be mounted onto a wall to save floor space and for their aesthetically pleasing appearance. As illustrated in FIG. 1, in many instances, a monitor 10 is mounted to a wall 12, and then a power cord 14 and an audio/video (AV) cable(s) 16 are routed to an AC outlet and an AV source, respectively. Note that the terms cord and cable may be used interchangeably in the descriptions herein, in particular, the term power cord may be also referred to as power cable. In some instance, a cabinet 18 may be placed underneath the monitor 10 to house the AV sources such as a receiver, DVD player, and/or cable box.

The power cable 14 and the AV cable 16 are often times routed along the outer surface of the wall because this may be the easiest and least expensive way to route the cables. One of the disadvantages to this method is that the exposed power cable 14 and AV cable 16 appear unsightly and unorganized. In situations when many AV cables such as HDMI® cables are used, it is difficult to trace which HMDI plug is connected to the HDMI plug in the opposite end of the cable, when the cables look alike. For these reasons, some route the power cable and the AV cable behind the drywall or plaster, and the cables need to marked accordingly to match the pair of HDMI plugs. In some instances, there may be a barrier such as insulation material and/or wooden beam that may make it difficult to rout the cable down behind the drywall. Moreover, routing the cables behind the drywall generally requires drilling a large hole into the drywall; and in some instances, a professional electrician may be necessary for the installation to meet the local electrical codes. Hiring an electrician, however, can take time and adds to the expense.

A variety of paintable covers are also available to hide the cords but these covers are thick, generally more than ½″ (12.7 mm), so that even after the cover is painted, the cover may be still noticeable on the wall. Moreover, many homes do not have a provision for an electrical outlet conveniently provided on the wall in preparation for a TV to be later wall mounted. In such circumstances, when the TV is mounted on the wall, the power cord for the TV may not be long enough to reach an electric outlet near the floor. For example, the TV power cord provided with the TV may be about 6 to 8 feet long; and when the TV is mounted onto a wall, it may be about 5 feet high from the floor, and if the electrical outlet near the floor is off to the side of the TV, the TV power cord may not reach the electrical out. In such a situation, an power cord may be needed to provide power to the TV. As such, there is a need to provide power and AV signals to the TV in a more convenient and aesthetically pleasing manner.

### INVENTION SUMMARY

This invention is directed to a cable management system (CMS) that provides electrical power and audio and video (AV) signals juxtaposed to a monitor. The CMS may include a cover having a first end and a second end. The cover may route electrical cord and AV cables. The combination of electrical cord and AV cables may have a first end and a second end. The combination may have receptacles for electrical power and (AV) signals in the first end adapted to couple to the electrical power plug from the monitor, and one or more AV plug ends from the monitor such as HDMI cables®. The first end of the combination of the electrical cord and AV cables may correspond with the first end of the cover, which may be adapted to be juxtaposed to the monitor. The second end of the combination of the electrical cord and AV cables may extend from the second end of the cover. The second end of the electrical cord may have an electrical plug to couple to an electrical outlet; and the second of the AV cables may have signal plugs adapted to couple to their respective AV components such as a cable box, DVD player, and the like.

The CMS may include a tray adapted to releasably couple the cover. The tray may have one or more channels adapted to receive the electrical cord and AV cables so that the tray may route the cord and cables in an organized manner. The tray may have a base adapted to adhere to a wall. The cover may have a substantially planner area to substantially overlap the tray. The cover may also have outer curve portions that drape toward the base of the tray. A portion of the curve portions of the cover may be a flap made of substantially softer material than the material forming the substantially planner area.

Another embodiment of a CMS is to have both ends of the AV cable to be plug ends like traditional HDMI® cables. In still another embodiment, the cover may have channels adapted to receive the combination of an electrical cord and AV cables to eliminate the need for a tray.

Other systems, methods, features, and advantages of the invention will be, or will become, apparent to one with skill in the art upon examination of the following figures and detailed description. It is intended that all such additional systems, methods, features, and advantages be included within this description, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 shows an illustration of a prior art.

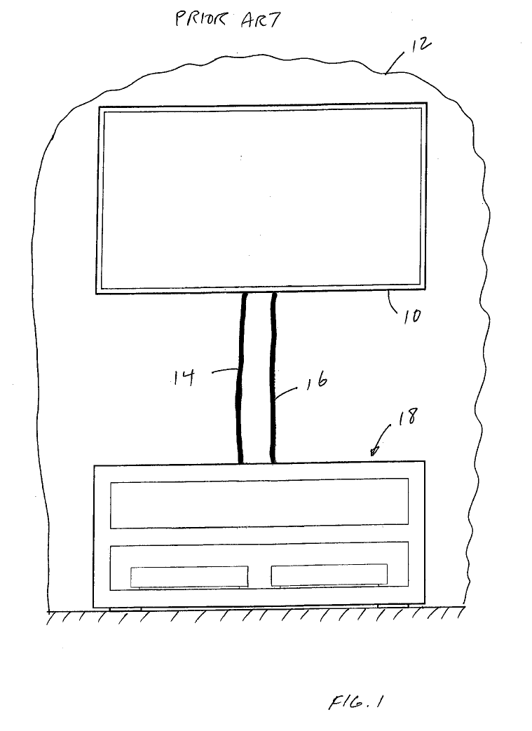

FIG. 2 shows a cable management system (CMS) adapted to provide AC power and AV signals to a monitor.

FIG. 3 shows a disassembled perspective view of the CMS of FIG. 2.

FIG. 4 shows a cross-sectional view of the CMS along the line A-A of FIG. 3.

FIG. 5 shows a cross-sectional view of a top cover releasably coupled to a bottom tray.

FIG. 6 shows a bottom side of the base of the tray.

FIG. 7 shows a front perspective view of a base bracket with a bracket cover removed.

FIG. 8 shows a close up view of the bracket cover.

FIG. 9 shows a second end of the cover.

FIG. 10 shows a disassembled perspective view of another CMS.

FIG. 11 shows the perspective view of a bracket cover of the CMS of FIG. 10.

FIG. 12 shows yet another embodiment of a CMS.

FIG. 13 shows still another embodiment of a CMS.

FIG. 14 shows a cross-sectional view of the CMS along the line B-B of FIG. 13.

### DETAILED DESCRIPTION OF THE INVENTION

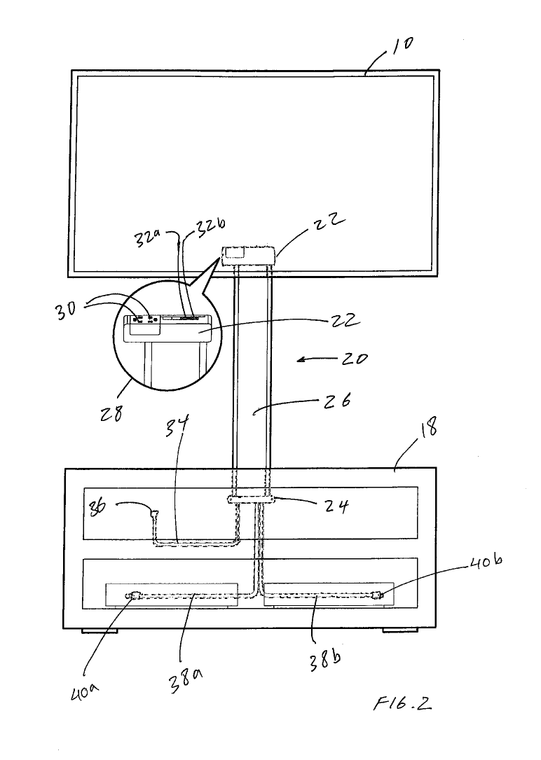

FIG. 2 shows a cable management system (CMS) 20 adapted to provide AC power and AV signals to the monitor 10. The CMS 20 has a first end 22 and a second end 24. The CMS 20 may be adapted to couple to the wall 12 and attached to the wall such that the first end 22 may extend behind the monitor, and the second end 24 may extend behind the cabinet 18. The CMS 20 may include a cover 26 between the first and second ends 22 and 24. The cover 26 may be adapted to receive paint so that it may paintable to match the color of the wall.

The encircle area 28 shows an enlarge view of the first end 22 of the CMS 22. The first end 22 may include one or more electrical receptacles 30 adapted to receive the plug end of the power cord 14, as illustrated in more detail below. The first end 22 may also include one or more signal receptacles 32a and 32b adapted to receive the plug end of the AV cables 16, as illustrated in more detail below. The electrical receptacles 30 may be coupled to an power cord 34 with a plug end 36, as shown in dotted lines. The power cord 34 may be routed through the cover 26, as discussed in more detail below, and extend out from the second end 24 so that the plug end 36 may be coupled to an electrical outlet (not shown). The extension cord may be rated for 120 volt for U.S. applications; and 240 volt for European and Asian applications. Each of the signal receptacles 32a and 32b may be coupled to their respective AV cable 38a and 38b. Each of the AV cables 38a and 38b may be coupled to their respective plug ends 40a and 40b. Each of the plug ends may be couple to their respective AV component such as a DVD player, cable box, Blue Ray player, and etc.

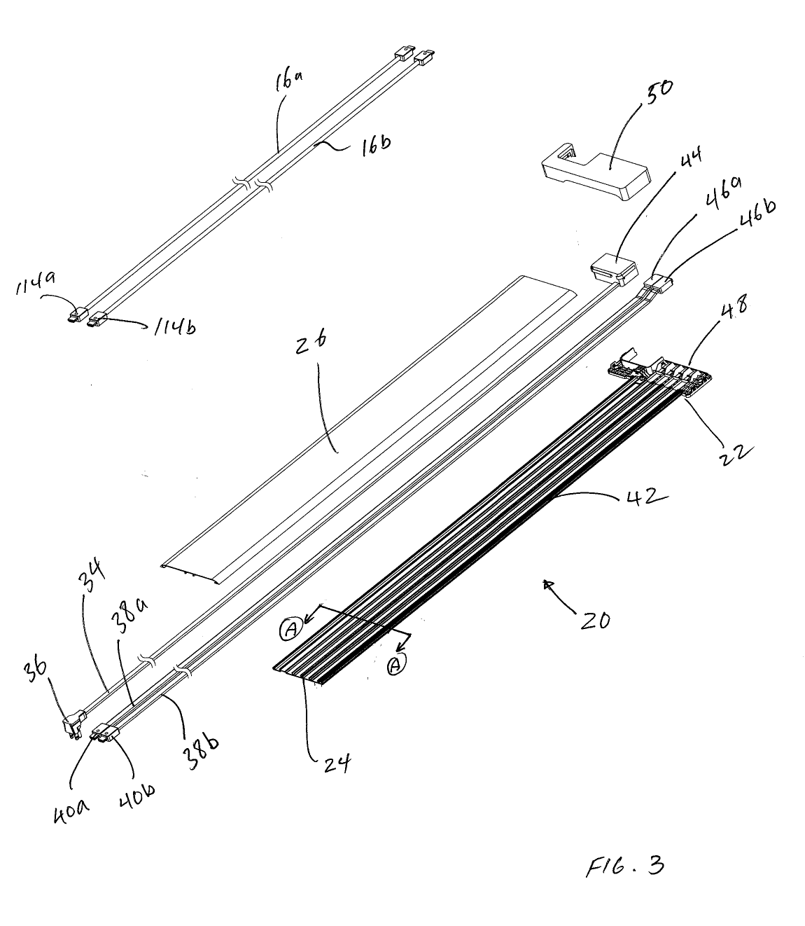

FIG. 3 shows a disassembled perspective view of the CMS 20 including a tray 42 adapted to receive the power cord 34 and the AV cables 38a and 38b between the first end 22 and the second end 24. The power cord 34 may have a receiving end 44 and the plug end 36. Each of the AV cables 38a and 38b may have their respective receiving end 46a and 46b on one side, and their respective plug end 40a and 40b on the opposite side. The first end 22 of the tray 42 may be coupled to a base bracket 48 adapted to receive the receiving ends 44, 46a, and 46b. The cover 26 and the tray 42 may be adapted to releasably couple to each other housing the power cord 34 and the AV cables 38a and 38b therein between. The CMS 20 may include a bracket cover 50 adapted to releasably couple to the base bracket 48 to house the receiving ends 44, 46a, and 46b therein between.

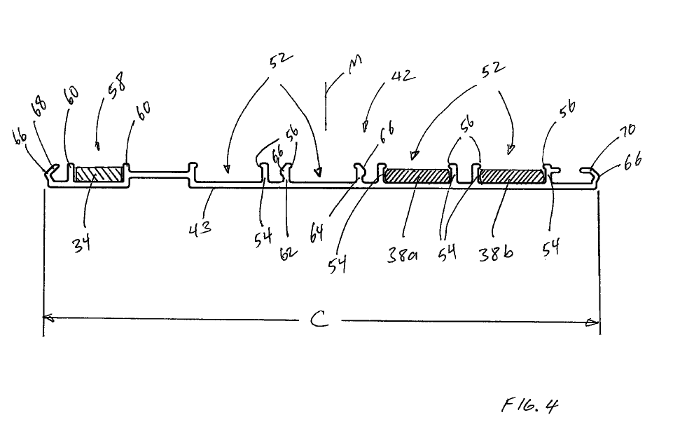

FIG. 4 shows a cross-sectional view of the tray 42 along the line A-A of FIG. 3. The tray 42 may have a base 43, which may have a substantially planer surface. The tray 42 may have one or more first channels 52 adapted to receive the AV cables 38a and 38b. In this embodiment, the tray 42 may have provisions to receive two more AV cables. Each channel 52 may have two side walls 54 protruding from the base 43, and each side wall 54 may have a protruding hook 56 adapted to hold the AV cable within the channel. The tray 42 may also have a second channel 58 adapted to receive the power cord 34 between two side walls 60. The two middle side walls 62 and 64 may each have a nose hook 66, and the two outer side walls 68 and 70 may each also have a nose hook 66. The midway point “M” between the two side walls 62 and 64 may align with the center point “C” between the two outer side walls 68 and 70.

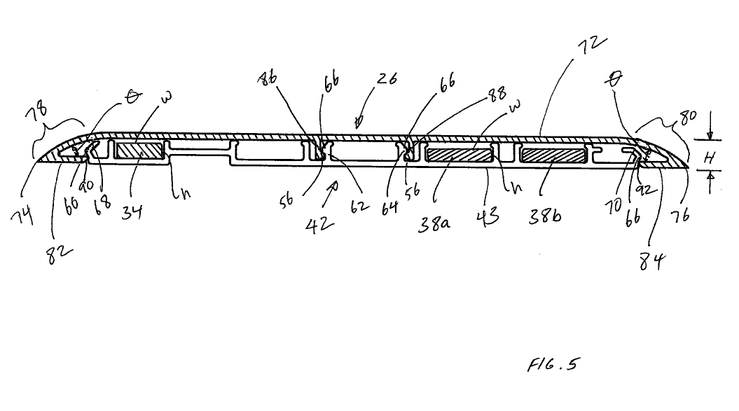

FIG. 5 shows the cover 26 releasably coupled to the tray 42 with the power cord 34 and AV cables 38a and 38b sandwiched therein between. The cover 26 may have a top surface area 72 between outer edges 74 and 76. The top surface area 72 may be substantially planer to cover the tray 42 between the outer side walls 68 and 70; and the top surface area 72 may have curve portions 78 and 80 to bend towards their respective edges 74 and 76. From the outer edges 74 and 76, the cover 26 may also have two fingers 82 and 84 that bend toward their respective side walls 68 and 70 of the tray 42. The two fingers 82 and 84 may have substantially planer surface substantially along the same planar surface as the base 43 of the tray 42 when the cover 26 is releasably coupled to the tray 42. The angle θ between the curve potions 78 and their respective fingers 82 and 84 may be between about 15° and about 50°; and preferably about 30° to minimize the shadowing effect such that as light shines on the cover 26, the shadow along the curve portions 78 and 80, and on the outer edges 74 and 76 may be minimized. Each of the fingers 82 and 84 may have their respective tip 90 and 92 adapted to engage with the nose hook 66 formed on the side walls 68 and 70, respectively.

The cover 26 may also have two side walls 86 and 88 with each side wall having a protruding hook 56 adapted to releasably couple to their respective nose hooks 66 formed on the middle side walls 62 and 64 of the tray 42. To couple the cover 26 onto the tray 42, the cover 26 may be aligned relative to the tray 42 such that the side walls 86 and 88 from the cover are juxtaposed to the side walls 62 and 64 of the tray; and the cover 26 may be pressed against the tray 42. The pressing action causes the joining side walls 62 and 86, and joining side walls 64 and 88 to bend away from each other to allow their respective protrusion hooks 56 and nose hooks 66 to engage with each other to releasably couple the joining side walls together. In addition, the two fingers 82 and 84 bend to allow the tips 90 and 92 to engage with their respective nose hooks 66 on the outer side walls 68 and 70.

As illustrated in FIG. 5, the power cord 34, and the AV cables 38a and 38b may have a substantially flat cross-section to minimize the overall height “H” of the cover 26 and tray 42 combination. The width “w” to height “h” ratio (w:h) of the power cord 34 may be between about 2:1 and about 3:1; and the ratio of the AV cables 38a and 38b may be between about 3:1 and about 5:1. In particular, the height “h” of the power cord 34 may be about 4.0 mm, and the height “h” of the AV cable may be about 3.6 mm. With these combinations, the overall height H may be between about 0.20 inch (5.1 mm) and about 0.40 inch (10.16 mm); and in another application between about 0.20 inch (5.1 mm) and about 0.31 inch (8.0 mm). In addition, the first and second channels 52 and 58 on the tray 42 may rout the cord 34 and the cables 38 through their respective channels such that the cord and cables run substantially parallel with respect to each other along the longitudinal axis of the tray 42 and cover 26. Thus, the channels prevent the cord and cables from crossing each other to minimize the height H of the cover 26.

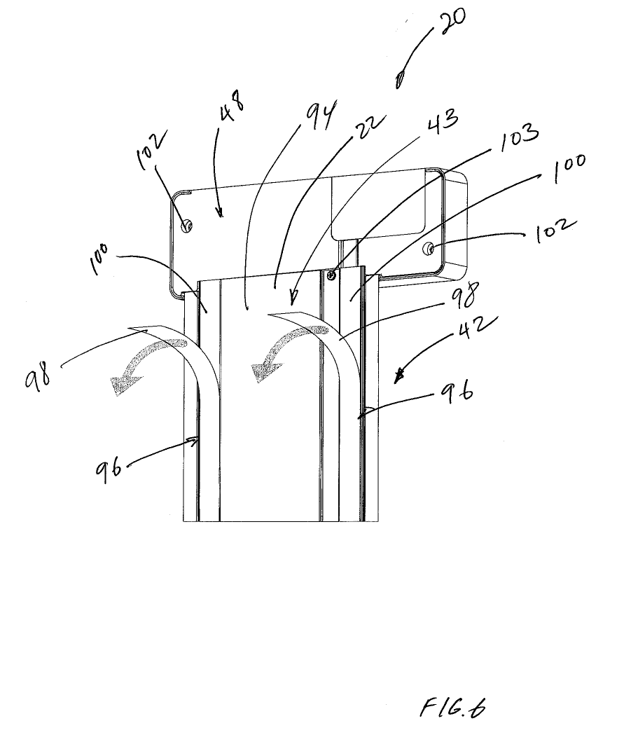

FIG. 6 shows a bottom side 94 of the base 43 of the tray 42. The bottom side 94 of the tray 42 may have one or more adhesive tape 96 with a removable liner 98 that may be peeled off to expose the adhesive side 100 of the tape 96. The adhesive tap 96 may be applied along the longitudinal axis of the tray 42. Once the liner 98 is removed, the CMS 20 may be coupled to the wall 12 temporarily or permanently onto the wall. The base bracket 48 may have one or more holes 102 adapted receive a screw to couple the base bracket 48 onto the wall 12. One or more screws 103 may be used to couple the first end 22 of the tray 42 and the cover 26 to the base bracket 48.

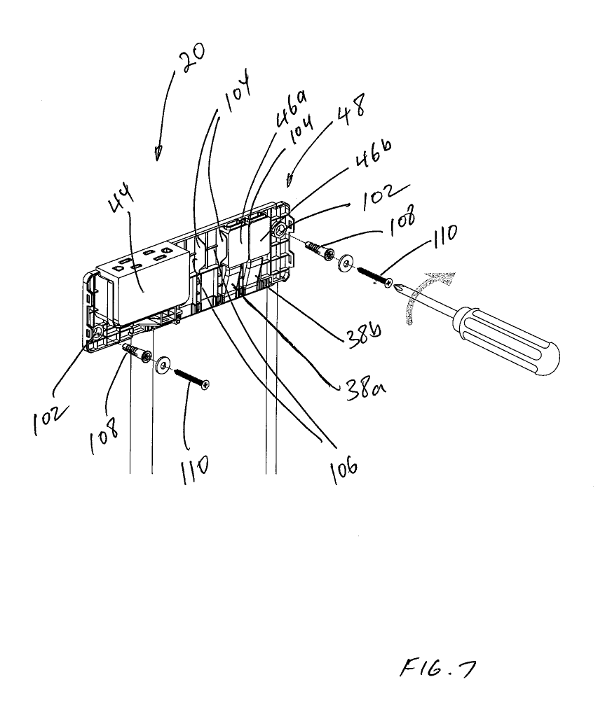

FIG. 7 shows a front perspective view of the base bracket 48 without the bracket cover 50. The base bracket 48 may have side walls 104 adapted to receive the receiving ends 46a and 46b of the AV cables 38a and 38b. In addition, the base bracket 48 may have provisions 106 to receive one or more additional receiving ends 46. The base bracket 48 may be also adapted to receive the receiving end 44 of the power cord 34. The base bracket 48 may have one or more holes 102 adapted to receive an anchor screw 108 and a screw 110 to couple the CMS 20 to the wall 12.

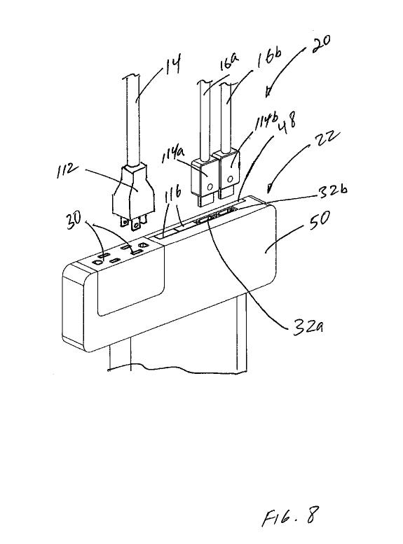

FIG. 8 shows the first end 22 of the CMS 20 with the bracket cover 50 releasably coupled to the base bracket 48 exposing one or more electrical receptacles 30 adapted to receive the plug end 112 of the power cord 14 provided with the monitor; and one or more signal receptacles 32a and 32b adapted to receive the plug ends 114a and 114b of the AV cables 16a and 16b connected to the monitor 10 such as from traditional HDMI® cables. The base bracket 48 and the cover 50 may have provisions 106 for one or more signal receptacles 32 by removing the corresponding tab 116.

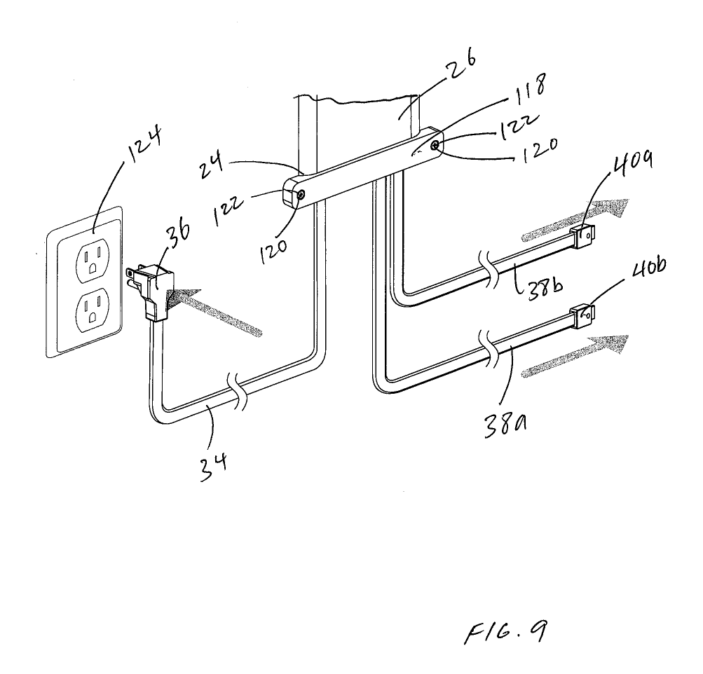

FIG. 9 shows a perspective view of the second end 24 of the cover 26. The CMS 20 may include a bottom bracket 118 to couple the second end 24 to the wall 12. The bottom bracket 118 may be adapted to overlap at least a portion of the second end 24 of the cover 26. The bottom bracket 18 may include one or more holes 120 adapted to receive a screw 122 to anchor the bottom bracket 118 to the wall. The power cord 34 may be routed through the cover 26, as discussed above in reference to FIG. 5, and extend out from the second end 24 so that the plug end 36 may be coupled to an electrical outlet 124. Each of the signal receptacles 32a and 32b (shown in FIG. 8) may be coupled to their respective AV cable 38a and 38b; and each of the AV cables 38a and 38b may have their respective plug ends 40a and 40b adapted to connect to their respective AV component such as a DVD player, cable box, Blue Ray player, and etc. As such, the AV signals from the AV components may be transmitted through the AV cables 38a and 38b, and provided in their respective signal receptacles 32a and 32b. With each of the AV cables 38a and 38b routed through the base 42 and cover 26 in an organized manner, it may be easier to identify the AV component signal provided in the first end through the signal receptacles 32a and 32b.

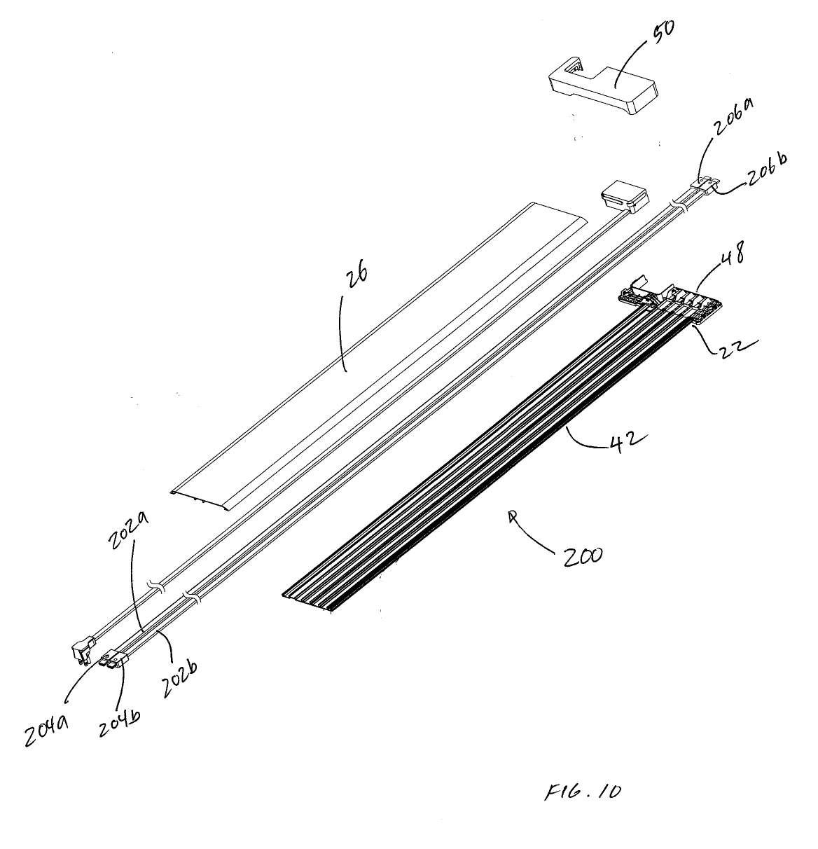

FIG. 10 shows a disassembled perspective view of the CMS 200, which is similar to the CMS 20 described above. The CMS may include the base bracket 48 coupled to the first end 22 of the tray 42, the cover adapted to releasably coupe to the tray 42, and the bracket cover 50 adapted to releasably couple to the base bracket 48. The CMS 200, however, may include one or more AV cables 202a and 202b where the opposite ends 204a and 206a, and 204b and 206b are both plug ends like traditional HDMI® cables with a plug on both ends, such that the ends 206a and 206b may directly couple the output jacks of the monitor 12. The CMS 200 may also include the power cord 34, as discussed above.

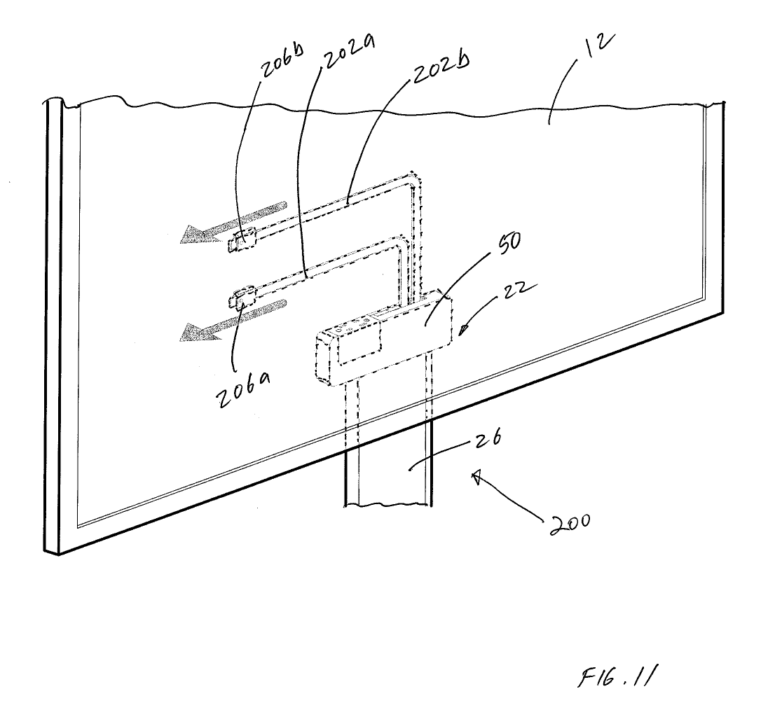

FIG. 11 shows the perspective view of the first end 22 of the CMS 200. The AV cables 202a and 202b may be sized to allow the cables to slide along the longitudinal axis of the tray 42 along their respective channels 52 so that the length of the AV cables 202a and 202b extending from the bracket cover 50 may be adjusted. This may allows the plug ends 206a and 206b to couple the AV output jacks from the monitor 12, and adjust the length of the cables 202a and 202b extending from the cover 50 to minimize the excess cables behind the monitor 12.

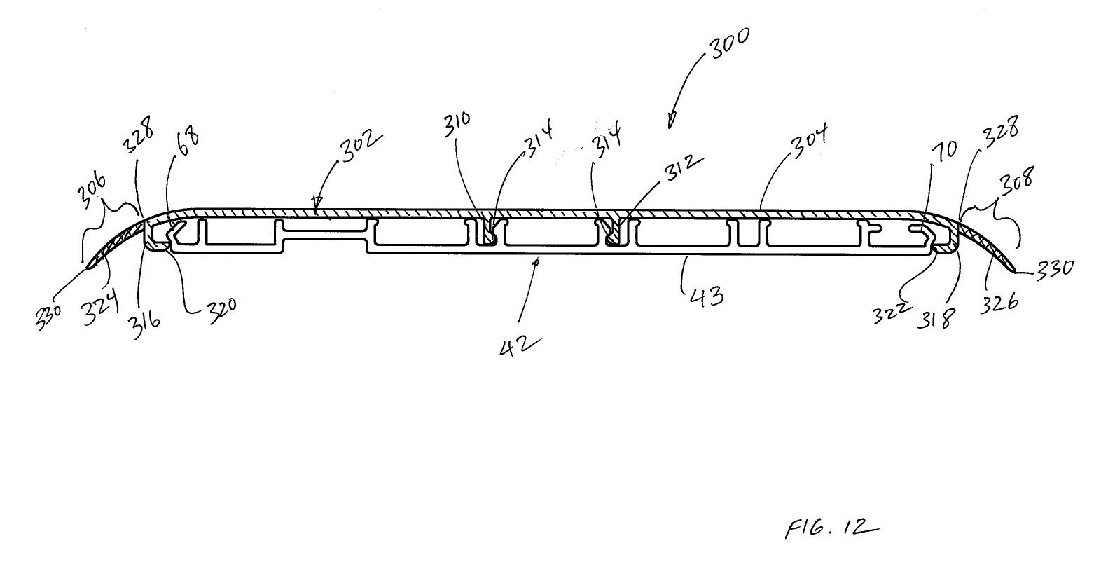

FIG. 12 shows another embodiment of CMS 300 with a cover 302 having a top surface area 304 substantially planer to cover the tray 42 between the outer side walls 68 and 70; and the top surface area 304 may have curve portions 306 and 308 to bend towards the base 43. The cover 302 may also have two side walls 310 and 312 with each side wall having a protruding hook 314, similar to the side walls 86 and 88 described above in reference to FIG. 5 above. Note that the midpoint between the side walls 310 and 312 may be substantially along the center of the cover 302. The cover 302 may also have two outer side walls 316 and 318 forming their respective tips 320 and 322 adapted to engage with the nose hooks 66 on the outer side walls 68 and 70 of the tray 42. Extending from the side walls 316 and 318, at least a portion of the curved portions 306 and 308 may be flaps 324 and 326. The flaps 324 and 326 may be made from a softer material than the top surface area 304 of the cover 302.

The flaps 306 and 308 may have proximal ends 328 and distal ends 330. The distal ends 330 may extend further down than the base 43 of the tray 42 so that the distal ends 330 may contour the surface of the wall 12 to minimize the gap between the flap and the wall to provide a seamless appearance. The proximal ends 328 of the flaps 324 and 326 may be coupled to their respective side walls 316 and 318 along the longitudinal axis of the cover 302 by extruding harder plastic material for the top surface area 304, and softer material for the flaps 324 and 326 simultaneously such that the two different materials adhere to each other as they cool during the extrusion process. For instance, the top surface area 304 may be extruded using a PVC material, and the flaps 324 and 326 may be extruded using a rubberize material.

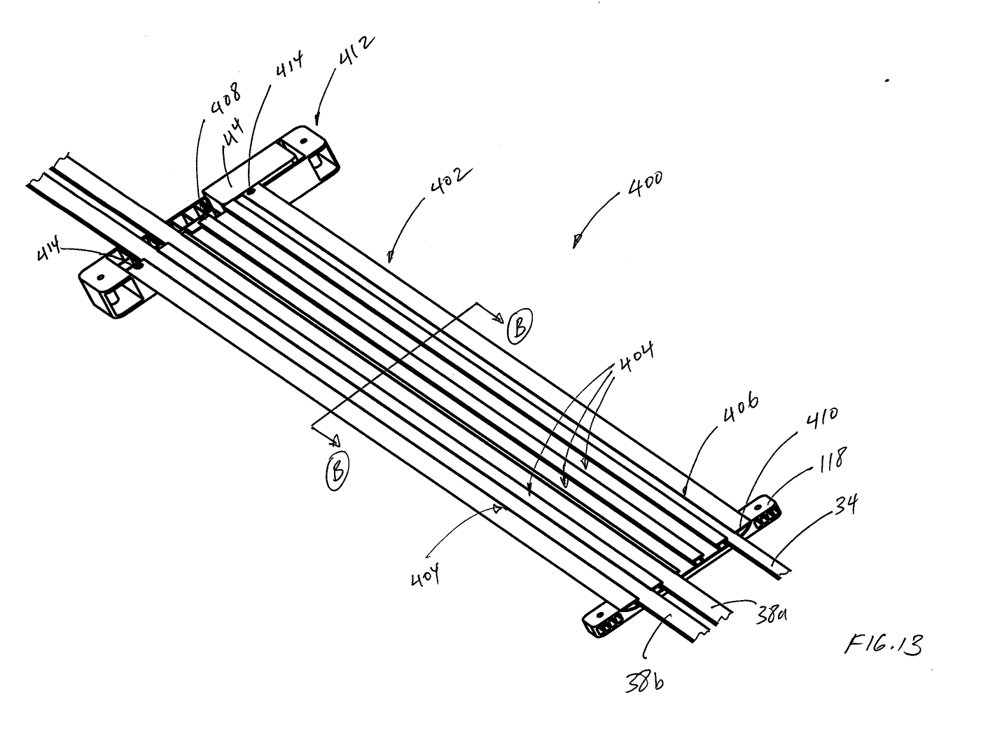

FIG. 13 shows a rear perspective view of another embodiment of a CMS 400. The CMS 400 includes a cover 402 having one or more first channels 404 adapted to receive the AV cables 38a and 38b; and a second channel 406 adapted to receive the power cord 34. The cover 402 may have a first end 408 adapted to couple to the bracket cover 412. The first end 408 may be coupled to the bracket cover 412 in a variety of ways such as by inserting one or more screws 414 through the first end 408 and into the bracket cover 412. The bracket cover 412 may be also adapted to couple to the receiving end 44 of the electrical cord 34. The second end 410 may be adapted to engage with the bottom bracket 118 to couple to the wall.

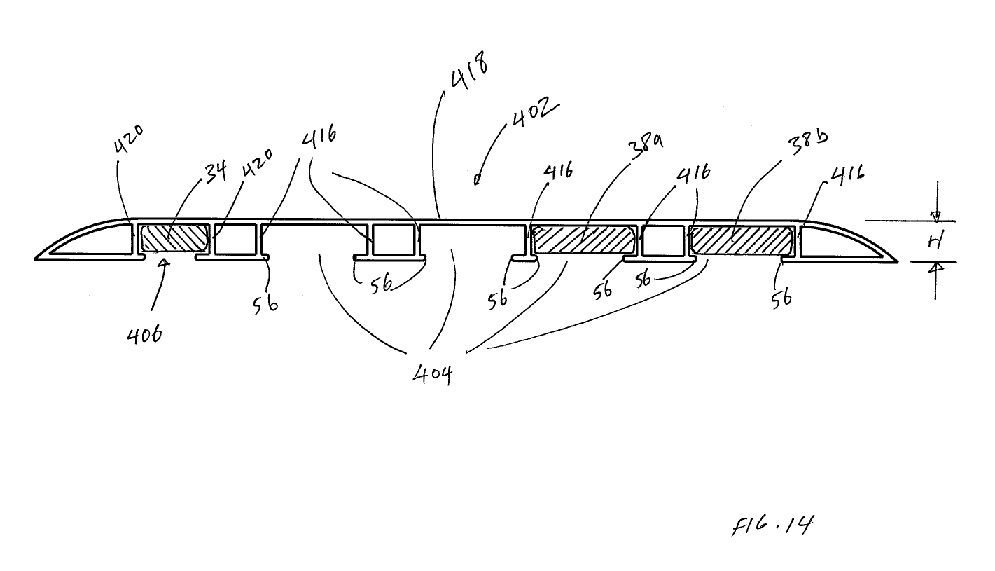

FIG. 14 shows a cross-sectional view of the cover 402 along the line B-B of FIG. 13. The cover 402 may have first channels 404 adapted to receive the AV cables 38a and 38b. Each channel 404 may have two side walls 416 protruding from the top surface 418, and each side wall 416 may have a protruding hook 56 adapted to hold the AV cable within the channel. The cover 402 may also have a second channel 406 adapted to receive the power cord 34 between two side walls 420. With the channels 404 and 406 formed on the cover 402, the CMS 400 may eliminate the need for a tray. And without the thickness of the tray, the overall height “H” of the cover 42 may be less than the height H of the cover 26 shown in FIG. 5. In particular, the height H of the cover 402 may be less than about 0.25 inch (6.35 mm).

While various embodiments of the invention have been described, it will be apparent to those of ordinary skill in the art that many more embodiments and implementations are possible within the scope of this invention. For instance, FIG. 8 shows the electrical receptacles 30 adapted to receive a standardized U.S. plug end; however, it is within the scope of this invention to have electrical receptacles end 30 adapted for use in European and Asia, and other countries depending on their electrical plug standardization. Moreover, other AV cables and cords may be paired with the AV cables such as an audio optical cord and coaxial cables. Accordingly, the invention is not to be restricted except in light of the attached claims and their equivalents.

What is claimed is:

1. A cable management system including:
an electrical cord having a receptacle end and a plug end;
a cable adapted to transmit signals, the cable having a first end and a second end;
a cover having a first end and a second end, the cover adapted to receive the electrical cord and the cable; and
a bracket cover adapted to couple to the first end of the cover, the bracket cover adapted to house the receptacle end of the electrical cord and the first end of the cable, and the electrical cord and the cable are substantially longer than a distance between the first and second ends of the cover such that the electrical cord and the cable extend from the second end of the cover when the cover receives the electrical cord and the cable.

2. The cable management system according to claim 1, including a tray adapted to releasably couple to the cover, the tray having a base adapted to couple to a wall, the tray having a first channel substantially along a longitudinal axis of the tray adapted to receive the cable, and a second channel substantially along the longitudinal axis of the tray adapted to receive the electrical cord.

3. The cable management system according to claim 2, where the tray has two middle side walls, and the cover has two middle side walls adapted to releasably couple to the two middle side walls of the tray.

4. The cable management system according to claim 2, including a base bracket adapted to receive the receptacle end of the electrical cord and the first end of the cable, the base bracket adapted to couple to the tray and releasably couple to the bracket cover.

5. The cable management system according to claim 1, where the cover has a first channel substantially along a longitudinal axis of the cover adapted to receive the cable, and a second channel substantially along the longitudinal axis of the cover adapted to receive the electrical cord.

6. The cable management system according to claim 1, where the electrical cord has a first substantially flat cross-section, and the cable has a second substantially flat cross-section.

7. The cable management system according to claim 6, where the second substantially flat cross-section of the cable has a width to height ratio of between about 3:1 and about 5:1.

8. The cable management system according to claim 1, where the first end of the cable is a plug end.

9. The cable management system according to claim 1, where the first end of the cable is a receptacle end adapted to receive a plug end from a HDMI® cable.

10. The cable management system according to claim 1, where the cover has a substantially planer area portion between two outer flaps, and the two outer flaps are made of substantially softer material than the substantially planner area portion of the cover.

11. The cable management system according to claim 1, where the cover has a cross-sectional height of between about 0.20 inch (5.1 mm) and about 0.31 inch (8.0 mm).

12. A cable management system including:
an electrical cord having a receptacle end and a plug end, and the electrical cord having a substantially flat cross-section;
a cable adapted to transmit signals, the cable having a first end and a second end, and the cable having a substantially flat cross-section;
a tray having a first end and a second end, the tray having at least one first channel adapted to receive the cable along a longitudinal axis of the tray between the first and second ends, and a second channel adapted to receive the electrical cord along the longitudinal axis such that the electrical cord and the cable are routed substantially parallel along the longitudinal axis of the tray;
a cover having a first end and a second end, the cover adapted to releasably couple to the tray such that the first and second ends of the tray and cover are juxtaposed to their respective ends when the cover is releasably coupled to the tray; and
a bracket cover adapted to couple to the first end of the cover, the bracket cover adapted to house the receptacle end of the electrical cord and the first end of the cable, and the electrical cord and the cable are longer than a distance between the first and second ends of the cover such that the electrical cord and the cable extend from the second end of the cover when the cover is coupled to the tray.

13. The cable management system according to claim 12, where the first end of the cable is a plug end.

14. The cable management system according to claim 12, where the first end of the cable is a receptacle end adapted to receive a plug end from a HDMI® cable.

15. The cable management system according to claim 12, where the cover has a substantially planer area portion between two outer flaps, and the two outer flaps are made of substantially softer material than the substantially planner area portion of the cover.

16. The cable management system according to claim 12, where when the cover is releasably coupled to the tray, a cross-sectional height of the cover and the tray is between about 0.20 inch (5.1 mm) and about 0.31 inch (8.0 mm).

17. A cable management system including:
an electrical cord having a receptacle end and a plug end, and the electrical cord having a substantially flat cross-section;
a cable adapted to transmit signals, the cable having a first end and a second end, and the cable having a substantially flat cross-section;
a tray having a first end and a second end, the tray having a first channel and a second channel, and the electrical cord routed within the second channel and the cable routed within the first channel along a longitudinal axis of the tray between the first and second ends such that the electrical cord and the cable are routed substantially parallel along the longitudinal axis of the tray;
a cover having a first end and a second end, the cover releasably coupled to the tray such that the first and second ends of the tray are juxtaposed to their respective ends; and
a bracket cover coupled to the first end of the cover, the bracket cover housing the receptacle end of the electrical cord and the first end of the cable, and the electrical cord and the cable extending from the second end of the cover.

18. The cable management system according to claim 17, where the first end of the cable is a plug end.

19. The cable management system according to claim 17, where the first end of the cable is a receptacle end adapted to receive a plug end from a HDMI® cable.

20. The cable management system according to claim 17, where the cover and the tray has a cross-sectional height of between about 0.20 inch (5.1 mm) and about 0.31 inch (8.0 mm).
